(19) United States
(12) Patent Application Publication
(10) Pub. No.: US 2026/0072547 A1
(43) Pub. Date: Mar. 12, 2026

(54) TOUCH DETECTION CIRCUIT, TOUCH CHIP, AND SCREEN MODULE

(71) Applicant: SHENZHEN GOODIX TECHNOLOGY CO., LTD., Shenzhen (CN)

(72) Inventor: Hao Xie, Shenzhen (CN)

(73) Assignee: SHENZHEN GOODIX TECHNOLOGY CO., LTD., Shenzhen (CN)

(21) Appl. No.: 19/387,848

(22) Filed: Nov. 13, 2025

Related U.S. Application Data
(63) Continuation of application No. PCT/CN2024/087202, filed on Apr. 11, 2024.

(51) Int. Cl. G06F 3/041; G06F 3/044

(52) U.S. Cl. CPC G06F 3/04182; G06F 3/0443

(57) ABSTRACT

A touch detection circuit, a touch chip, and a screen module are provided. The touch detection circuit is configured to process input signals to obtain a touch signal corresponding to each of the electrodes. The touch signal is used to indicate a touch state of a touch region where the electrode is located. When no finger touch is present, a touch signal corresponding to each of the electrodes is a first touch signal; and when a finger touch is present, a touch signal corresponding to one of the electrodes located in a touch region with the finger touch is a second touch signal, a touch signal corresponding to one of the electrodes located in a touch region without the finger touch is a third touch signal, and each of the second touch signal and the third touch signal is different from the first touch signal.

### CROSS REFERENCE

The present disclosure is a continuation application of PCT/CN2024/087202 filed on Apr. 11, 2024 titled “TOUCH DETECTION CIRCUIT, TOUCH CHIP, AND SCREEN MODULE”, which is in incorporated herein by reference in its entirety.

### TECHNICAL FIELD

Embodiments of the present disclosure relate to the technical field of electronics, and in particular to, a touch detection circuit, a touch chip, and a screen module.

### BACKGROUND

With the increase in screen size and advancements in a screen manufacturing process, a screen touch sensor and display interference are increasingly severely coupled, and the display interference coupled to the screen touch sensor is increased, thereby reducing a signal to noise ratio (SNR) of a touch signal obtained by the screen touch sensor, and then resulting in low touch recognition accuracy during touch recognition based on the touch signal.

At present, the touch signal is amplified to recognize a valid touch signal in the touch signal.

However, significant display interference is coupled to the screen touch sensor. Therefore, the display interference occupies a large portion of a dynamic range of the touch signal, while the valid touch signal occupies only a small portion of the dynamic range, and the valid touch signal remains small after the touch signal is amplified, thereby resulting in low touch detection accuracy based on the valid touch signal.

### SUMMARY

In view of this, embodiments of the present disclosure provide a touch detection circuit, a touch chip, and a screen module, to at least partially solve the above problems.

An embodiment in a first aspect of the present disclosure provides a touch detection circuit, connected to a plurality of electrodes; wherein the touch detection circuit is configured to process input signals inputted from the plurality of electrodes to obtain a touch signal corresponding to each of the electrodes, wherein the touch signal is used to indicate a touch state of a touch region where the electrode is located; when no finger touch is present, a touch signal corresponding to each of the electrodes is a first touch signal; and when a finger touch is present, a touch signal corresponding to one of the electrodes located in a touch region with the finger touch is a second touch signal, a touch signal corresponding to one of the electrodes located in a touch region without the finger touch is a third touch signal, and each of the second touch signal and the third touch signal is different from the first touch signal.

In a possible implementation, a signal number of the second touch signal is negatively correlated with the number of the electrodes located in the touch region with the finger touch, and a signal number of the third touch signal is positively correlated with the number of the electrodes located in the touch region with the finger touch.

In a possible implementation, a sum of the signal number of the second touch signal and the signal number of the third touch signal is equal when different numbers of the electrodes are located in the touch region with the finger touch.

In a possible implementation, the touch detection circuit comprises an analog-to-digital conversion module, and the touch signal is outputted from the analog-to-digital conversion module.

In a possible implementation, the touch detection circuit comprises: an amplification module and a feedback module; wherein the amplification module comprises a plurality of amplification submodules, different amplification submodules being connected to different electrodes; the feedback module is configured to generate an error signal based on an output signal outputted from each of the amplification submodules and transmit the error signal to each of the amplification submodules, wherein the error signal is used to indicate a mean intensity of an interference signal coupled to each of the electrodes; and the amplification submodule is configured to output the output signal based on the input signal inputted from one of the electrodes connected to the amplification submodule and the error signal, wherein the output signal is used to generate the touch signal corresponding to the electrode connected to the amplification submodule.

In a possible implementation, the feedback module comprises an accumulation submodule, a switching submodule, and a mean value amplification submodule; wherein a plurality of input ends of the accumulation submodule are connected to the amplification submodules respectively; two input ends of the mean value amplification submodule are connected to the accumulation submodule and the switching submodule respectively, an output end of the mean value amplification submodule is connected to an input end of each of the amplification submodules; the accumulation submodule is configured to obtain an accumulated current based on the output signal from each of the amplification submodules and transmit the accumulated current to the mean value amplification submodule, wherein the accumulated current is used to indicate a total intensity of the interference signal coupled to each of the electrodes; the switching submodule is configured to transmit a reference voltage signal to the mean value amplification submodule; and the mean value amplification submodule is configured to generate the error signal based on the accumulated current and the reference voltage signal, and transmit the error signal to each of the amplification submodules.

In a possible implementation, the amplification submodule comprises a first amplifier, a first resistor, a second resistor, and a first capacitor; wherein a first end of the first resistor is connected to the electrode, a second end of the first resistor is connected to an inverting input end of the first amplifier; a first end of the second resistor is connected to the inverting input end of the first amplifier, a second end of the second resistor is connected to an output end of the first amplifier; a first end of the first capacitor is connected to the inverting input end of the first amplifier, a second end of the first capacitor is connected to the output end of the first amplifier; a non-inverting input end of the first amplifier is connected to the mean value amplification submodule, the output end of the first amplifier is connected to the accumulation submodule, the first amplifier transmits the output signal to the accumulation submodule via the output end, and the mean value amplification submodule transmits the error signal to the non-inverting input end of the first amplifier.

In a possible implementation, the accumulation submodule comprises a plurality of third resistors; wherein a first end of each of the third resistors is connected to the output end of the first amplifier, a second end of the third resistor is connected to an input end of the mean value amplification submodule, the first ends of different third resistors are connected to different first amplifiers, and the second ends of the different third resistors are connected to a given input end of the mean value amplification submodule.

In a possible implementation, the mean value amplification submodule comprises: a second amplifier, a second capacitor, a third capacitor, a fourth resistor, and a fifth resistor; wherein a non-inverting input end of the second amplifier is connected to the switching submodule, an inverting input end of the second amplifier is connected to a first end of the fifth resistor, a second end of the fifth resistor is connected to the second end of each of the third resistors; an output end of the second amplifier is connected to the non-inverting input end of each of the first amplifiers, a first end of the fourth resistor is connected to the output end of the second amplifier, a second end of the fourth resistor is connected to a first end of the third capacitor, a second end of the third capacitor is connected to the inverting input end of the second amplifier; a first end of the second capacitor is connected to the output end of the second amplifier, and a second end of the second capacitor is connected to the inverting input end of the second amplifier.

In a possible implementation, the mean value amplification submodule comprises: a third amplifier, a fourth capacitor, a fifth capacitor, a sixth capacitor, a sixth resistor, a seventh resistor, and an eighth resistor; wherein a non-inverting input end of the third amplifier is connected to the switching submodule, an inverting input end of the third amplifier is connected to a first end of the eighth resistor, a second end of the eighth resistor is connected to the second end of each of the third resistors; an output end of the third amplifier is connected to the non-inverting input end of each of the first amplifiers, a first end of the sixth resistor is connected to an output end of the third amplifier, a second end of the sixth resistor is connected to a first end of the fifth capacitor, a second end of the fifth capacitor is connected to a first end of the fourth capacitor, a second end of the fourth capacitor is connected to a first end of the seventh resistor, a second end of the seventh resistor is connected to a second end of the eighth resistor; a first end of the sixth capacitor is connected to the output end of the third amplifier, and a second end of the sixth capacitor is connected to the second end of the fifth capacitor and the inverting input end of the third amplifier respectively.

In a possible implementation, the mean value amplification submodule comprises: a fourth amplifier, a seventh capacitor, an eighth capacitor, a ninth resistor, a tenth resistor, and an eleventh resistor; wherein a non-inverting input end of the fourth amplifier is connected to the switching submodule, an inverting input end of the fourth amplifier is connected to a first end of the eleventh resistor, a second end of the eleventh resistor is connected to the second end of each of the third resistors; an output end of the fourth amplifier is connected to the non-inverting input end of each of the first amplifiers, a first end of the ninth resistor is connected to the output end of the fourth amplifier, a second end of the ninth resistor is connected to a first end of the eighth capacitor, a second end of the eighth capacitor is connected to a first end of the seventh capacitor and the inverting input end of the fourth amplifier respectively, a second end of the seventh capacitor is connected to a first end of the tenth resistor, and a second end of the tenth resistor is connected to the second end of the eleventh resistor.

In a possible implementation, the mean value amplification submodule comprises: a fifth amplifier, a ninth capacitor, a twelfth resistor, and a thirteenth resistor; wherein a non-inverting input end of the fifth amplifier is connected to the switching submodule, an inverting input end of the fifth amplifier is connected to a first end of the thirteenth resistor, a second end of the thirteenth resistor is connected to the second end of each of the third resistors; a first end of the twelfth resistor is connected to an output end of the fifth amplifier, a second end of the twelfth resistor is connected to a first end of the ninth capacitor, and a second end of the ninth capacitor is connected to the inverting input end of the fifth amplifier.

In a possible implementation, the switching submodule comprises: a first DC voltage source, a first driving unit, a first switch, and a second switch; wherein an output end of the switching submodule is connected to a first end of the first switch and a first end of the second switch respectively, a second end of the first switch is connected to the first DC voltage source, a second end of the second switch is connected to the first driving unit; in a mutual capacitive mode, the first switch is switched on, the second switch is switched off, and the first DC voltage source transmits a DC voltage as the reference voltage signal to the output end of the switching submodule; and in a self-capacitive mode, the first switch is switched off, the second switch is switched on, and the first driving unit transmits a self-capacitive driving signal as the reference voltage signal to the output end of the switching submodule, wherein the self-capacitive driving signal outputted from the first driving unit is equal to a driving signal acting on the electrode.

In a possible implementation, the touch detection circuit further comprises a plurality of processing modules, each of the processing modules comprising a filter, a sample holder, and a buffer submodule; wherein an output end of the filter is connected to an input end of the sample holder, an output end of the sample holder is connected to an input end of the buffer submodule, and an output end of the buffer submodule is connected to an input end of the analog-to-digital conversion module, wherein the second ends of the different third resistors are connected to input ends of the filters in different processing modules, the output ends of the buffer submodules in the different processing modules are connected to the input ends of different analog-to-digital conversion modules; the filter is configured to filter the input signal and remove the reference voltage signal included in the input signal to obtain a touch voltage signal; the sample holder is configured to sample the touch voltage signal to obtain a target signal and hold the target signal; and the buffer submodule is configured to transmit the target signal changelessly to the analog-to-digital conversion module, so that the analog-to-digital conversion module converts the target signal into the touch signal.

In a possible implementation, the non-inverting input end of each of the first amplifiers is connected to the input end of the filter in one of the processing modules.

In a possible implementation, the filter comprises: a differential amplifier, a second DC voltage source, a second driving unit, a third switch, a fourth switch, a fourteenth resistor, a fifteenth resistor, a sixteenth resistor, a seventeenth resistor, an eighteenth resistor, a nineteenth resistor, a tenth capacitor, an eleventh capacitor, and a twelfth capacitor; wherein a first end of the fourteenth resistor is connected to the second end of the third resistor, wherein the second ends of the different third resistors are connected to the first ends of the fourteenth resistors in different filters; a second end of the fourteenth resistor is connected to a first end of the sixteenth resistor, a second end of the sixteenth resistor is connected to a positive input end of the differential amplifier, a first end of the seventeenth resistor is connected to a first end of the sixteenth resistor, a second end of the seventeenth resistor is connected to a negative output end of the differential amplifier, a first end of the eleventh capacitor is connected to a second end of the sixteenth resistor, a second end of the eleventh capacitor is connected to the negative output end of the differential amplifier; a first end of the fifteenth resistor is connected to a first end of the third switch and a first end of the fourth switch respectively, a second end of the third switch is connected to the second DC voltage source, a second end of the fourth switch is connected to the second driving unit; a second end of the fifteenth resistor is connected to a first end of the eighteenth resistor, a second end of the eighteenth resistor is connected to a negative input end of the differential amplifier, a first end of the nineteenth resistor is connected to a first end of the eighteenth resistor, a second end of the nineteenth resistor is connected to a positive output end of the differential amplifier, a first end of the twelfth capacitor is connected to the second end of the eighteenth resistor, a second end of the twelfth capacitor is connected to the positive output end of the differential amplifier; a first end of the tenth capacitor is connected to the first end of the sixteenth resistor, a second end of the tenth capacitor is connected to the first end of the eighteenth resistor, the positive output end and the negative output end of the differential amplifier are connected to the sample holder respectively; in a mutual capacitive mode, the third switch is switched on, the fourth switch is switched off, and the second DC voltage source outputs a DC voltage same as the reference voltage signal; and in a self-capacitive mode, the third switch is switched off, the fourth switch is switched on, and the second driving unit outputs a driving signal equal to the reference voltage signal.

According to an embodiment in a second aspect of the present disclosure, a touch chip is provided, comprising the touch detection circuit according to the first aspect.

According to an embodiment in a third aspect of the present disclosure, a screen module is provided, comprising: a plurality of electrodes and the touch chip according to the above second aspect; wherein each of the electrodes is configured to receive a touch drive signal outputted from the touch chip, so that the screen module recognizes a touch instruction, wherein the electrodes are horizontal electrodes and/or vertical electrodes arranged on the touch screen.

According to the solutions of the embodiments of the present disclosure, the touch detection circuit can sum the output signal from each of the electrodes and suppress display interference and a base signal using a mean error of feedforwards, thereby enabling a valid touch signal to have a large dynamic range, and improving the touch recognition accuracy.

### BRIEF DESCRIPTION OF DRAWINGS

To more clearly describe technical solutions of embodiments of the present disclosure or the prior art, drawings to be used in the description of the embodiments or the prior art will be briefly introduced below. Apparently, the drawings in the description below are merely some embodiments disclosed in the embodiments of the present disclosure. For those of ordinary skills in the art, other drawings may also be obtained based on these drawings.

FIG. 1 is a schematic diagram of a touch detection circuit in an embodiment of the present disclosure;

FIG. 2 is a schematic diagram of a touch detection circuit in another embodiment of the present disclosure;

FIG. 3 is a schematic diagram of a touch detection circuit in still another embodiment of the present disclosure;

FIG. 4 is a schematic diagram of a touch detection circuit in yet another embodiment of the present disclosure;

FIG. 5 is a schematic structural diagram of a circuit of a mean value amplification submodule provided in an embodiment of the present disclosure;

FIG. 6 is a schematic structural diagram of a circuit of a mean value amplification submodule in another embodiment of the present disclosure;

FIG. 7 is a schematic structural diagram of a circuit of a mean value amplification submodule in still another embodiment of the present disclosure;

FIG. 8 is a schematic structural diagram of a circuit of a mean value amplification submodule in yet another embodiment of the present disclosure;

FIG. 9 is a schematic diagram of a phase margin evaluation result in an embodiment of the present disclosure;

FIG. 10 is a schematic diagram of a suppression effect on a mutual capacitive driving base in an embodiment of the present disclosure;

FIG. 11 is a schematic diagram of a suppression effect on display interference in an embodiment of the present disclosure;

FIG. 12 is a schematic diagram of a mutual capacitive touch diff effect in an embodiment of the present disclosure;

FIG. 13 is a schematic diagram of a mutual capacitive touch diff effect in another embodiment of the present disclosure;

FIG. 14 is a schematic diagram of a self-capacitive touch diff effect in an embodiment of the present disclosure;

FIG. 15 is a schematic diagram of a self-capacitive touch diff effect in another embodiment of the present disclosure; and

FIG. 16 is a schematic diagram of a screen module in an embodiment of the present disclosure.

### DETAILED DESCRIPTION

To enable those skilled in the art to better understand technical solutions of embodiments of the present disclosure, the technical solutions of the embodiments of the present disclosure will be clearly and completely described below with reference to the drawings in the embodiments of the present disclosure. Apparently, the described embodiments are merely some, instead of all, of the embodiments of the present disclosure. All other embodiments obtained by those of ordinary skills in the art based on some embodiments among the embodiments of the present disclosure should be encompassed within the scope of protection of the embodiments of the present disclosure.

The terms used in the present disclosure are intended merely to describe particular embodiments, and are not intended to limit the present disclosure. The singular forms of “a” and “the” used in the present disclosure and the appended claims are also intended to include plural forms, unless the context explicitly indicates other meanings. It should be further understood that the term “and/or” used herein refers to and includes any or all possible combinations of one or more associated enumerated items.

It should be understood that various kinds of information may be described by using the terms, such as first, second, and third, in the present disclosure, but the information should not be limited to these terms. These terms are merely used to distinguish between information of a same type. For example, the first information may also be referred to as the second information, and similarly, the second information may also be referred to as the first information, without departing from the scope of the present disclosure. Depending on the context, as used herein, the word “if” may be interpreted as “at the time of . . . ” or “when . . . ” or “in response to determining.”

### Touch Detection Circuit

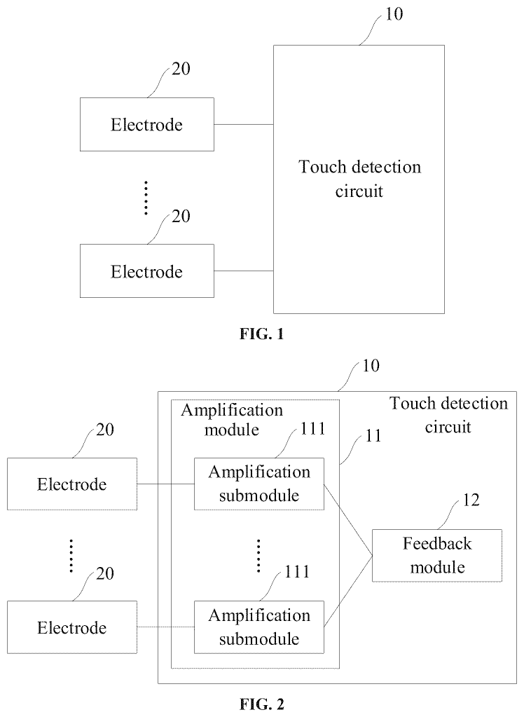

FIG. 1 is a schematic diagram of a connection between a touch detection circuit in a touch chip and an electrode on a touch screen in an embodiment of the present disclosure. As shown in FIG. 1, the touch detection circuit 10 is connected to a plurality of electrodes 20. The touch detection circuit 10 can receive input signals from the electrodes 10 and process the input signals, to obtain a touch signal corresponding to each of the electrodes. The touch signal can indicate a touch state of a touch region where a corresponding electrode is located.

When no finger touch is present, a touch signal corresponding to each of the electrodes is defined as a first touch signal. When a finger touch is present, a touch signal corresponding to one of the electrodes located in a touch region with the finger touch is defined as a second touch signal, and a touch signal corresponding to one of the electrodes located in a touch region without the finger touch is defined as a third touch signal. The first touch signal, the second touch signal, and the third touch signal satisfy the following condition: each of the second touch signal and the third touch signal is different from the first touch signal.

The electrode 20 on the touch screen may comprise horizontal electrodes and vertical electrodes arranged on the touch screen. When a finger touches the touch screen, coupling capacitance of the electrode located in the touch region with the finger touch changes, and then the touch signal corresponding to the electrode changes, so that a touch position of the finger on the touch screen can be determined based on the touch signal corresponding to each electrode, thereby achieving touch detection.

When the finger touches the touch screen, the touch signal corresponding to the electrode located in the touch region with the finger touch is the second touch signal, and the touch signal corresponding to the electrode located in the touch region without the finger touch is the third touch signal. The second touch signal is different from the third touch signal. Then, the touch region of the finger on the touch screen can be determined based on the touch region where the electrode with the corresponding touch signal being the second touch signal is located on the touch screen.

During touch detection, the touch region can be determined based on a touch diff corresponding to each electrode. The touch diff can be calculated based on the touch signal corresponding to the electrode. In an example, the first touch signal is used as a reference signal, and a difference between the touch signal corresponding to the electrode and the first touch signal is used as the touch diff. When no finger touch is present, the touch signal corresponding to each of the electrodes is the first touch signal. In this case, the touch diff is equal to 0. When the finger touch is present, the touch diff corresponding to the electrode located in the touch region with the finger touch is a difference between the second touch signal and the first touch signal, and the touch diff corresponding to the electrode located in the touch region without the finger touch is a difference between the third touch signal and the first touch signal. When the finger touches the touch screen, the touch diff corresponding to the electrode located in the touch region with the finger touch is different from the touch diff corresponding to the electrode located in the touch region without the finger touch, and then the finger touch region can be determined based on the touch diff corresponding to each electrode.

The electrodes 20 may comprise the horizontal electrodes and the vertical electrodes arranged on the touch screen, wherein the horizontal electrodes are arranged perpendicular to the vertical electrodes. For a capacitive touch screen, during touch recognition, a self-capacitive mode, a mutual capacitive mode, or a combination mode thereof may be used for touch recognition. In the self-capacitive mode, the touch signal is generated based on capacitance value change of ground capacitance of a drive electrode, and in the mutual capacitive mode, the touch signal is generated based on capacitance value change of capacitance between the drive electrode and a sensing electrode. The electrode 20 will be coupled to display interference, and in the self-capacitive mode, the electrode will also generate a base signal (driving base) due to its own ground capacitance (or coupling capacitance) when no finger touch is present. Therefore, the output signal from the electrode 20 during the touch includes the display interference, the base signal, and a valid touch signal. The valid touch signal is used for touch recognition. Compared to the valid touch signal, the display interference and the base signal are interference signals.

During driving, the base signal and the display interference occupy a dynamic range. This solution is mainly intended to eliminate or reduce the impact of the base signal and the display interference on the dynamic range, thereby only amplifying the valid touch signal during the touch, and obtaining a higher SNR.

Display interference coupled to different electrodes 20 is substantially identical, and base signals on the different electrodes 20 are also substantially identical.

In the self-capacitive mode, the electrodes 20 comprise the horizontal electrodes and the vertical electrodes on the touch screen. In the mutual capacitive mode, the electrodes 20 comprise sensing electrodes on the touch screen.

The touch detection circuit 10 can sum the output signal from each electrode 20, and then feed back a mean error corresponding to each electrode 20 based on the summation result, to suppress the display interference and the base signal in the output signal from each electrode 20, so that the valid touch detection signal has a large dynamic range. When the finger does not touch the touch screen, each electrode 20 outputs a consistent output signal. After feedback of the mean error, the touch signal corresponding to each electrode 20 remains consistent, that is, when the finger touch is present, the touch signal corresponding to each electrode 20 is the first touch signal. When the finger touches the touch screen, the output signal outputted from the electrode 20 located in the touch region with the finger touch is different from the output signal outputted from the electrode 20 located in the touch region without the finger touch. After feedback of the mean error, both the touch signal corresponding to the electrode 20 located in the touch region with the finger touch and the touch signal corresponding to the electrode located in the touch region without the finger touch change relative to the first touch signal, so that the touch signal corresponding to the electrode 20 located in the touch region with the finger touch is the second touch signal, while the touch signal corresponding to the electrode 20 located in the touch region without the finger touch is the third touch signal, and the second touch signal is different from the third touch signal.

In an embodiment of the present disclosure, the touch detection circuit 10 can sum the output signal from each electrode 20, and suppress the display interference and the base signal using a mean error of feedforwards, thereby enabling the valid touch signal to have a large dynamic range, and improving the touch recognition accuracy.

In a possible implementation, a signal number of the second touch signal is negatively correlated with the number of the electrodes 20 located in the touch region with the finger touch, and a signal number of the third touch signal is positively correlated with the number of the electrodes 20 located in the touch region with the finger touch.

When the display interference and the base signal are suppressed using the mean error of the feedforwards, the touch signal corresponding to the electrode 20 located in the touch region with the finger touch is equal to a difference between the touch signal before suppression and the mean error, while the touch signal corresponding to the electrode 20 located in the touch region without the finger touch is equal to a sum of the touch signal before suppression and the mean error. The mean error is positively correlated with the number of electrodes 20 located in the touch region with the finger touch, so that the second touch signal is negatively correlated with the number of electrodes 20 located in the touch region with the finger touch, while the signal number of the third touch signal is positively correlated with the number of electrodes 20 located in the touch region with the finger touch.

During the finger touch, the touch signal corresponding to the electrode 20 located in the touch region without the finger touch before suppression is equal to 0, so that the third touch signal is equal to the mean error.

In an embodiment of the present disclosure, the signal number of the second touch signal is negatively correlated with the number of the electrodes 20 located in the touch region with the finger touch, and the signal number of the third touch signal is positively correlated with the number of the electrodes 20 located in the touch region with the finger touch, thereby ensuring effective suppression of the display interference and the base signal when the touch screen is touched on a small area and when the touch screen is touched on a large area, and improving the touch recognition accuracy.

In a possible implementation, a sum of the signal number of the second touch signal and the signal number of the third touch signal is equal when different numbers of the electrodes 20 are located in the touch region with the finger touch.

The touch signal corresponding to the electrode 20 located in the touch region with the finger touch is equal to the difference between the touch signal before suppression and the mean error, that is, the second touch signal is equal to the difference between the touch signal of the corresponding electrode 20 before suppression and the mean error. The touch signal corresponding to the electrode 20 located in the touch region without the finger touch is equal to the sum of the touch signal before suppression and the mean error, that is, the third touch signal is equal to the sum of the touch signal of the corresponding electrode 20 before suppression and the mean error. During the finger touch, the touch signal corresponding to the electrode 20 located in the touch region without the finger touch before suppression is equal to 0, so that the third touch signal is equal to the mean error, and then the sum of the second touch signal and the third touch signal is equal to the touch signal corresponding to the electrode 20 located in the touch region with the finger touch before suppression, and the touch signal corresponding to the electrode 20 located in the touch region with the finger touch before suppression is a constant value, so that the sum of the second touch signal and the third touch signal is independent of the number of electrodes 20 located in the touch region with the finger touch, and the sum of the signal number of the second touch signal and the signal number of the third touch signal is identically equal to the touch signal corresponding to the electrode 20 located in the touch region with the finger touch before suppression.

In an example, a mean error of the second touch signal V₂=V₀(1−N) and the third touch signal V₃=NV₀ is equal to NV₀, wherein V₀ represents the touch signal of the electrode 20 located in the touch region with the finger touch before suppression, N represents the number of electrodes 20, and n represents the number of electrodes 20 located in the touch region with the finger touch. As can be seen, V₂+V₃=V₀, independent of the number of electrodes 20 located in the touch region with the finger touch.

In an embodiment of the present disclosure, when different numbers of electrodes 20 are located in the touch region with the finger touch, the sum of the signal number of the second touch signal and the signal number of the third touch signal is equal. No matter whether the finger touch is on a small area or on a large area, the display interference and the base signal can be effectively suppressed, thereby resulting in accurate touch recognition no matter whether the finger touch is on a small area or on a large area, and ensuring the touch recognition accuracy.

In a possible implementation, the touch detection circuit 10 comprises an analog-to-digital conversion module, and the touch signal is outputted from the analog-to-digital conversion module, that is, the touch signal corresponding to each electrode 20 can be detected via an output end of the analog-to-digital conversion module.

In an example, the touch signal corresponding to each electrode 20 may be accessed through a Serial Peripheral Interface (SPI).

In an embodiment of the present disclosure, the touch detection circuit 10 comprises the analog-to-digital conversion module, which can convert an analog signal into a digital signal, thereby obtaining the touch signal in the form of a digital signal, so that a microcontroller unit (MCU) determines a finger touch position based on the touch signal in the form of the digital signal.

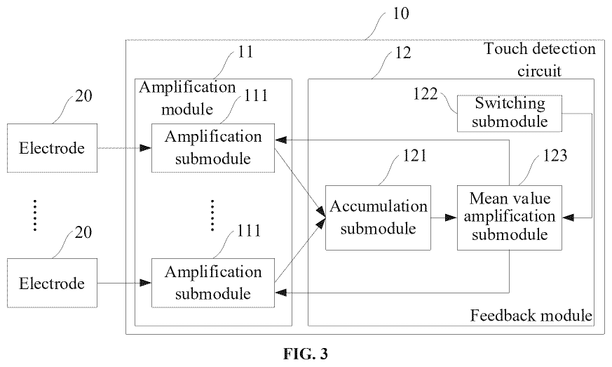

FIG. 2 is a schematic diagram of a touch detection circuit in another embodiment of the present disclosure. As shown in FIG. 2, the touch detection circuit 10 comprises an amplification module 11 and a feedback module 12. The amplification module 11 comprises a plurality of amplification submodules 111, different amplification submodules 111 being connected to the different electrodes 20.

A feedback module 12 is connected to output ends of the plurality of amplification submodules 111. The feedback module 12 may be configured to generate an error signal based on an output signal outputted from each of the amplification submodules 111 and transmit the error signal to each of the amplification submodules 111, wherein the error signal can indicate a mean intensity of an interference signal coupled to each of the electrodes 20. After receiving the input signal and the error signal inputted from the connected electrode 20, the amplification submodule 111 can output the output signal based on the received input signal and error signal. The output signal is used to generate the touch signal corresponding to the electrode 20 connected to the amplification submodule 111.

In an embodiment of the present disclosure, the amplification submodule 111 can output the output signal based on the input signal from the electrode 20, and the feedback module 12 can generate the error signal based on the output signal from each amplification submodule 111, so that the error signal can indicate a mean intensity of the interference signal coupled to each electrode 20, and then feed back the error signal to the amplification submodule 111. The amplification submodule 111 can suppress the interference signal in the input signal based on the error signal, thereby reducing the interference signal in the output signal, so that the valid touch signal in the output signal has a large dynamic range, thereby improving the touch recognition accuracy during touch recognition based on the output signal.

In a possible implementation, the feedback module 12 can accumulate the output signal from each amplification submodule 111, and then obtain a mean value of the accumulation results as the error signal.

FIG. 3 is a schematic diagram of a touch detection circuit 10 in another embodiment of the present disclosure. As shown in FIG. 3, the feedback module 12 comprises an accumulation submodule 121, a switching submodule 122, and a mean value amplification submodule 123.

A plurality of input ends of the accumulation submodule 121 are connected to the amplification submodules 111 respectively. Two input ends of the mean value amplification submodule 123 are connected to the accumulation submodule 121 and the switching submodule 122 respectively, and an output end of the mean value amplification submodule 123 is connected to an input end of each of the amplification submodules 111.

The accumulation submodule 121 can obtain an accumulated current based on the output signal from each of the amplification submodules 111 and transmit the accumulated current to the mean value amplification submodule 123, wherein the accumulated current can indicate a total intensity of the interference signal coupled to each of the electrodes 20. The switching submodule 122 can transmit a reference voltage signal to the mean value amplification submodule 123. The mean value amplification submodule 123 can generate the error signal based on the accumulated current and the reference voltage signal, and transmit the error signal to each of the amplification submodules 111.

The output signal from the amplification submodule 111 is a voltage signal. The accumulation submodule 121 can convert this voltage signal into a current signal, and then accumulate the converted current signals to obtain the accumulated current, so that the accumulated current can indicate the total intensity of the interference signal coupled to each electrode 20.

Since the touch chip is usually powered by a single power supply, the switching submodule 122 transmits the reference voltage signal as a bias to the mean value amplification submodule 123, so that the mean value amplification submodule 123 averages and amplifies the reference voltage signal and the accumulated current. The generated error signal is a positive signal, and the output signal from the amplification submodule 111 is also a positive signal, thereby ensuring normal processing by a post-circuit.

The mean value amplification submodule 123 generates an error signal that can indicate the mean intensity of the interference signal coupled to each electrode 20 based on the reference voltage signal and the accumulated current, allows the error signal to be a positive signal, and then feeds back the error signal to each amplification submodule 111, so that the amplification submodule 111 can suppress the interference signal in the input signal based on the error signal, thereby reducing the interference signal in the output signal from the amplification submodule 111.

In an embodiment of the present disclosure, the accumulation submodule 121 obtains the accumulated current based the output signal from each amplification submodule 111, so that the accumulated current can indicate the total intensity of the interference signal coupled to each electrode. After the accumulated current is transmitted to the mean value amplification submodule 123, the mean value amplification submodule 123 obtains the error signal by amplification, so that the error signal may indicate the mean intensity of the interference signal coupled to each electrode 20, and then feeds back the error signal to each amplification submodule 111, so that the amplification submodule 111 suppresses the display interference and the base signal in the input signal, thereby reducing the interference signal included in the output signal from the amplification submodule 111.

In a possible implementation, the amplification submodule 111 may suppress the display interference and the base signal in the input signal by negative feedback.

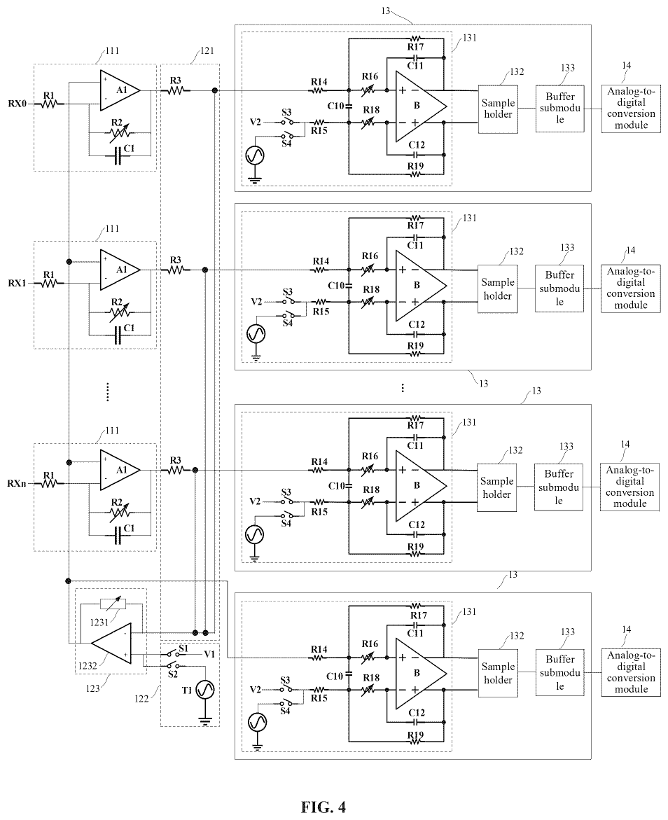

FIG. 4 is a schematic diagram of a touch detection circuit in still another embodiment of the present disclosure. As shown in FIG. 4, the amplification submodule 111 comprises a first amplifier A1, a first resistor R1, a second resistor R2, and a first capacitor C1.

A first end of the first resistor R1 is connected to the electrode 20, and a second end of the first resistor R1 is connected to an inverting input end of the first amplifier A1. Electrodes RX0-RXn are connected to different amplification submodules 111 respectively, and the first ends of the first resistors R1 in different amplification submodules 111 are connected to the different electrodes 20, for example, the electrodes RX0, RX1, and RXn are connected to the first ends of the different first resistors R1.

A first end of the second resistor R2 is connected to the inverting input end of the first amplifier A1, and a second end of the second resistor R2 is connected to an output end of the first amplifier A1.

A first end of the first capacitor C1 is connected to the inverting input end of the first amplifier A1, and a second end of the first capacitor C1 is connected to the output end of the first amplifier A1.

A non-inverting input end of the first amplifier A1 is connected to the mean value amplification submodule 123, and the non-inverting input ends of a plurality of first amplifiers A1 are connected to the output end of the mean value amplification submodule 123. The output end of the first amplifier A1 is connected to the accumulation submodule 121, and the output ends of the plurality of first amplifiers A1 are connected to a plurality of output ends of the accumulation submodule 121 respectively. The first amplifier A1 transmits the output signal to the accumulation submodule 121 via the output end, and the mean value amplification submodule 123 transmits the error signal to the non-inverting input end of the first amplifier A1.

The amplification submodule 111 comprises the first amplifier A1, wherein the inverting input end of the first amplifier A1 is connected to the electrode 20 via the first resistor R1, a voltage signal outputted from the electrode 20 is converted into a current signal via the first resistor R1, the current signal is inputted into the first amplifier A1, and the first amplifier A1 outputs a voltage signal. Therefore, the amplification submodule 111 is implemented as a trans-impedance amplifier.

It should be noted that the first amplifier A1 may be a Programmable Gain Amplifier (PGA).

In an embodiment of the present disclosure, the amplifier submodule 111 comprises the first amplifier A1, wherein the non-inverting input end of the first amplifier A1 is connected to the mean value amplification submodule 123, the inverting input end of the first amplifier A1 is connected to the electrode 20 via the first resistor R1, the mean value amplification submodule 123 transmits the error signal to the non-inverting input end of the first amplifier A1, and an input signal inputted from the electrode 20 is inputted into the inverting input end of the first amplifier A1 via the first resistor R1. When the amplification submodule 111 reaches a steady state, the non-inverting input end and the inverting input end of the first amplifier A1 are virtually short-circuited, and the interference signal in the voltage signal inputted into the inverting input end of the first amplifier A1 is suppressed, so that the voltage signal outputted from the first amplifier A1 comprises less interference signal. The interference signal in the input signal is eliminated by negative feedback, so that the valid touch signal in the voltage signal outputted from the first amplifier A1 has a large dynamic range. The voltage signal outputted from the first amplifier A1 is processed by the post-circuit, and then used for touch recognition, thereby improving the touch recognition accuracy.

In a possible implementation, as shown in FIG. 4, the accumulation submodule 121 comprises a plurality of third resistors R3, wherein a first end of each of the third resistors R3 is connected to the output end of the first amplifier A1, and a second end of the third resistor R3 is connected to an input end of the mean value amplification submodule 123. Each third resistor R3 among the plurality of third resistors R3 can match each first amplifier A1. The first ends of different third resistors R3 are connected to the output ends of different first amplifiers A1, and the second ends of the different third resistors R3 are connected to a given input end of the mean value amplification submodule 123.

The third resistors R3 may have an equal resistance value, or may have different resistance values. This embodiment of the present disclosure does not impose any limitation on the resistance values of the third resistors R3.

In an embodiment of the present disclosure, the amplification submodule 111 is implemented as a trans-impedance amplifier, the first amplifier A1 outputs the voltage signal, which is converted into a current signal via the third resistor R3, and the second ends of the third resistors R3 are each connected to the given input end of the mean value amplification submodule 123, that is, the current inputted from the accumulation submodule 121 into the mean value amplification submodule 123 is the accumulated current of each channel. Since the voltage signal outputted from the first amplifier A1 comprises the interference signal, and the current signal converted from the voltage signal via the third resistor R3 also comprises the interference signal, the accumulated current can indicate the total intensity of the interference signal coupled to each electrode 20. Since the interference signals coupled to the different electrodes 20 are substantially identical, the error signal for indicating the mean intensity of the interference signal coupled to each electrode 20 is determined based on the accumulated current, to ensure that the error signal can accurately reflect the interference signal coupled to the electrode 20.

In a possible implementation, the mean value amplification submodule 123 obtains the mean error (error signal) of different channels by amplification, and then feeds back the mean value to the amplification submodule 111 of each channel for suppression of the display interference and the base signal. As shown in FIG. 4, the mean value amplification submodule 123 comprises an amplifier 1231 and a loop stability compensation unit 1232. When the third resistors R3 have an equal resistance value, a ratio of the resistance value of the third resistor R3 to a resistance value of the loop stability compensation unit 1232 is equal to the number of third resistors R3. Each of the amplification submodule 111 and the accumulation submodule 121, and each of the switching submodule 122 and the mean value amplification submodule 123 can form a feedback loop. The loop stability compensation unit 1232 can compensate stability of the feedback loop by combination of resistors and capacitors, so that a phase margin is greater than 45° and a gain margin is greater than 10 Db, thereby ensuring that the feedback loop will not have self-excited oscillation, and ensuring the processing stability of the touch detection circuit 10 on the touch signal.

Since the loop stability compensation unit 1232 can compensate stability of the feedback loop by combination of resistors and capacitors, the loop stability compensation unit 1232 has a variety of different forms, thereby making the mean value amplification submodule 123 have a variety of circuit structures. FIGS. 5-8 show four circuit structures of the mean value amplification submodule 123. A possible circuit structure of the mean value amplification submodule 123 is described below.

As shown in FIG. 5, the mean value amplification submodule 123 comprises a second amplifier A2, a second capacitor C2, a third capacitor C3, a fourth resistor R4, and a fifth resistor R5. A non-inverting input end of the second amplifier A2 is connected to the switching submodule 122, an inverting input end of the second amplifier A2 is connected to a first end of the fifth resistor R5, and a second end of the fifth resistor R5 is connected to the second end of each of the third resistors R3. An output end of the second amplifier A2 is connected to the non-inverting input end of each of the first amplifiers A1, a first end of the fourth resistor R4 is connected to the output end of the second amplifier A2, a second end of the fourth resistor R4 is connected to a first end of the third capacitor C3, and a second end of the third capacitor C3 is connected to the inverting input end of the second amplifier A2. A first end of the second capacitor C2 is connected to the output end of the second amplifier A2, and a second end of the second capacitor C2 is connected to the inverting input end of the second amplifier A2.

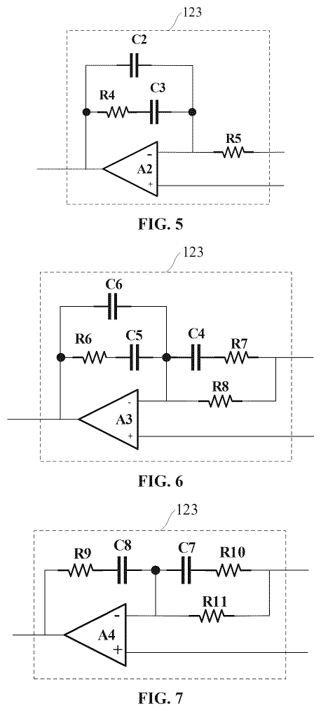

As shown in FIG. 6, the mean value amplification submodule 123 comprises a third amplifier A3, a fourth capacitor C4, a fifth capacitor C5, a sixth capacitor C6, a sixth resistor R6, a seventh resistor R7, and an eighth resistor R8. A non-inverting input end of the third amplifier A3 is connected to the switching submodule 122, an inverting input end of the third amplifier A3 is connected to a first end of the eighth resistor R8, and a second end of the eighth resistor R8 is connected to the second end of each of the third resistors R3. An output end of the third amplifier A3 is connected to the non-inverting input end of each of the first amplifiers A1, a first end of the sixth resistor R6 is connected to an output end of the third amplifier A3, a second end of the sixth resistor R6 is connected to a first end of the fifth capacitor C5, a second end of the fifth capacitor C5 is connected to a first end of the fourth capacitor C4, a second end of the fourth capacitor C4 is connected to a first end of the seventh resistor R7, and a second end of the seventh resistor R7 is connected to a second end of the eighth resistor R8. A first end of the sixth capacitor C6 is connected to the output end of the third amplifier A3, and a second end of the sixth capacitor C6 is connected to the second end of the fifth capacitor C5 and the inverting input end of the third amplifier A3 respectively.

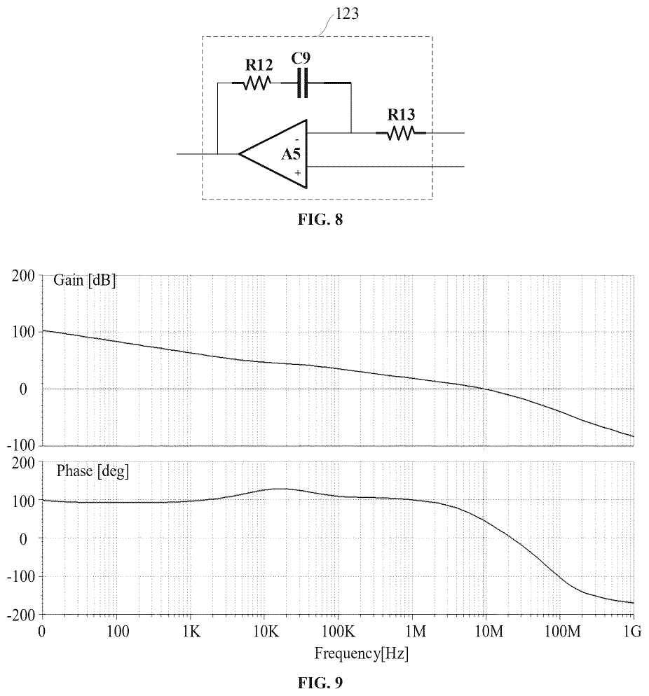

As shown in FIG. 7, the mean value amplification submodule 123 comprises a fourth amplifier A4, a seventh capacitor C7, an eighth capacitor C8, a ninth resistor R9, a tenth resistor R10, and an eleventh resistor R11. A non-inverting input end of the fourth amplifier A4 is connected to the switching submodule 122, an inverting input end of the fourth amplifier A4 is connected to a first end of the eleventh resistor R11, and a second end of the eleventh resistor R11 is connected to the second end of each of the third resistors R3. An output end of the fourth amplifier A4 is connected to the non-inverting input end of each of the first amplifiers A1, a first end of the ninth resistor R9 is connected to the output end of the fourth amplifier A4, a second end of the ninth resistor R9 is connected to a first end of the eighth capacitor C8, a second end of the eighth capacitor C8 is connected to a first end of the seventh capacitor C7 and the inverting input end of the fourth amplifier A4 respectively, a second end of the seventh capacitor C7 is connected to a first end of the tenth resistor R10, and a second end of the tenth resistor R10 is connected to the second end of the eleventh resistor R11.

As shown in FIG. 8, the mean value amplification submodule 123 comprises a fifth amplifier A5, a ninth capacitor C9, a twelfth resistor R12, and a thirteenth resistor R13. A non-inverting input end of the fifth amplifier A5 is connected to the switching submodule 122, an inverting input end of the fifth amplifier A5 is connected to a first end of the thirteenth resistor R13, and a second end of the thirteenth resistor R13 is connected to the second end of each of the third resistors R3. A first end of the twelfth resistor R12 is connected to an output end of the fifth amplifier A5, a second end of the twelfth resistor R12 is connected to a first end of the ninth capacitor C9, and a second end of the ninth capacitor C9 is connected to the inverting input end of the fifth amplifier A5.

In an embodiment of the present disclosure, the mean value amplification submodule 123 comprises a loop stability compensation unit formed by combination of resistors and capacitors. While the mean value amplification submodule 123 obtains the mean error (error signal) of each channel by amplification, the loop stability compensation unit can correct stability of the feedback loop, so that the phase margin is greater than 45° and the gain margin is greater than 10 Db, thereby ensuring that the feedback loop will not have self-excited oscillation, and ensuring the processing stability of the touch detection circuit 10 on the touch signal.

In a possible implementation, the switching submodule 122 transmits the reference voltage signal to the mean value amplification submodule 123, the reference voltage signal is biased to allow the error signal outputted from the mean value amplification submodule 123 to be a positive signal, and then the amplification submodule 111 can amplify the input signal that may be either positive or negative and is inputted from the electrode 20 into the output signal that is a positive signal based on the error signal, to facilitate processing by the post-circuit, and satisfy the requirements for single power supply design of the touch chip.

A driving signal of a sinusoidal waveform is applied to the drive electrode in the self-capacitive mode, and a DC voltage signal is applied to the drive electrode in the mutual capacitive mode. In order to suppress the display interference in the input signal in both the self-capacitive mode and the mutual capacitive mode, and suppress the base signal in the self-capacitive mode, the switching submodule 122 needs to transmit different reference voltage signals to the mean value amplification submodule 123 in the self-capacitive mode and the mutual capacitive mode. Specifically, a DC level is transmitted to the mean value amplification submodule 123 as a bias in the mutual capacitive mode, and the driving signal of the sinusoidal waveform is transmitted to the mean value amplification submodule 123 as a bias in the self-capacitive mode.

As shown in FIG. 4, the switching submodule 122 comprises a first DC voltage source V1, a first driving unit T1, a first switch S1, and a second switch S2. An output end of the switching submodule 122 is connected to a first end of the first switch S1 and a first end of the second switch S2 respectively, a second end of the first switch S1 is connected to the first DC voltage source V1, and a second end of the second switch S2 is connected to the first driving unit T1.

In the mutual capacitive mode, the first switch S1 is switched on, the second switch S2 is switched off, and the first DC voltage source V1 transmits a DC voltage (DC level) as the reference voltage signal to the output end of the switching submodule 122.

In the self-capacitive mode, the first switch S1 is switched off, the second switch S2 is switched on, and the first driving unit T1 transmits a self-capacitive driving signal as the reference voltage signal to the output end of the switching submodule 122, wherein the self-capacitive driving signal outputted from the first driving unit T1 is equal to a driving signal acting on the electrode 20.

In an embodiment of the present disclosure, the switching submodule 122 comprises the first switch S1 and the second switch S2, wherein the first switch S1 is connected to the first DC voltage source V1, and the second switch S2 is connected to the first driving unit T1. In the mutual capacitive mode, the first switch S1 is switched on, the second switch S2 is switched off, and the switching submodule 122 transmits the DC level outputted from the first DC voltage source V1 to the mean value amplification submodule 123 as a bias. In the self-capacitive mode, the first switch S1 is switched off, the second switch S2 is switched on, and the switching submodule 122 transmits the self-capacitive driving signal outputted from the first driving unit T1 to the mean value amplification submodule 123 as a bias, thereby ensuring that the amplification submodule 111 outputs a positive signal in both the self-capacitive mode and the mutual capacitive mode, which is convenient for processing by the post-circuit, and is adapted to a touch chip with single power supply design, thereby improving the adaptability of the touch detection circuit 10.

In a possible implementation, the touch detection circuit 10 further comprises a plurality of processing modules. Output ends of the different amplification submodules 111 are connected to different processing modules via the accumulation submodule 121, and the plurality of output ends of the accumulation submodule 121 are connected to the different processing modules respectively. The output signals from the amplification submodules 111 are processed by the accumulation submodule 121, and then filtered by corresponding processing modules.

As shown in FIG. 4, the touch detection circuit 10 further comprises the plurality of processing modules 13, each of the processing modules 13 comprising a filter 131, a sample holder 132, and a buffer submodule 133.

An output end of the filter 131 is connected to an input end of the sample holder 132, an output end of the sample holder 132 is connected to an input end of the buffer submodule 133, and an output end of the buffer submodule 133 is connected to an input end of the analog-to-digital conversion module 14. The second ends of the different third resistors R3 are connected to input ends of the filters 131 in the different processing modules 13. The output ends of the buffer submodules 133 in the different processing modules 13 are connected to the input ends of different analog-to-digital conversion modules 14.

The filter 131 can filter the input signal and remove the reference voltage signal in the input signal to obtain a touch voltage signal. The sample holder 132 can sample the touch voltage signal to obtain a target signal and hold the target signal. After the sample holder 132 transmits the target signal to the buffer submodule 133, the analog-to-digital conversion module 14 can extract the target signal from the buffer submodule 133, the buffer submodule 133 can ensure that the target signal remains unchanged when the analog-to-digital conversion module 14 extracts the target signal, thereby ensuring that the target signal has sufficient driving power for the analog-to-digital conversion module 14 to convert the target signal into a digital signal.

In an embodiment of the present disclosure, since the switching submodule 122 will transmit the reference voltage signal to the mean value amplification submodule 123, the mean value amplification submodule 123 transmits the error signal to the amplification submodule 111 based on the accumulated current and the reference voltage signal, and the amplification submodule 111 outputs the output signal based on the error signal and the input signal inputted from the electrode. The output signal is converted into the input signal of the filter 131 via the third resistor R3, so that the input signal of the filter 131 is mixed with the reference voltage signal. While filtering its input signal, the filter 131 can remove the reference voltage signal mixed in its input signal, so that the touch voltage signal outputted from the filter 131 can accurately indicate the touch state, thereby ensuring the touch recognition accuracy.

The analog-to-digital conversion module 14 may fail to process the touch voltage signal outputted from the filter 131 in time. The sample holder 132 can hold the touch voltage signal. Then, after completing processing a prior signal, the analog-to-digital conversion module 14 can process the touch voltage signal held by the sample holder 132 to ensure that the touch voltage signal outputted from the filter 131 can be processed by the analog-to-digital conversion module 14, to avoid touch recognition errors caused by partial touch voltage signal outputted from the filter 131 not being processed by the analog-to-digital conversion module 14.

In a possible implementation, the non-inverting input end of each of the first amplifiers A1 is connected to the input end of the filter 131 in one of the processing modules 13.

The second end of each third resistor R3 is connected to one of the processing modules 13, the second ends of the different third resistors R3 are connected to the different processing modules 13, and the non-inverting input ends of the first amplifiers A1 are connected to a given processing module 13, so that a total number of processing modules 13 is equal to the number of third resistors R3 plus 1.

The non-inverting input end of each first amplifier A1 is connected to the output end of the mean value amplification submodule 123. Therefore, the processing module 13 is connected to the output end of the mean value amplification submodule 123. The error signal outputted from the mean value amplification submodule 123 will be transmitted to the processing module 13 connected to the non-inverting input end of each first amplifier A1. Specifically, the error signal will be transmitted to the input end of the filter 131. The filter 131 can filter the inputted error signal, remove the reference voltage signal in the error signal, and then transmit the processed error signal to the connected sample holder 132.

It should be noted that the processing mode of the processing module 13 on the error signal is same as the processing mode of the signal outputted from the second end of the third resistor R3, and will not be repeated here.

During touch recognition, a touch position needs to be determined based on a difference (diff) between touch signals of different channels (digital signals converted from touch voltage signals). When a touch screen or a touch pad is touched on a large area, for example, when a touch phone is placed in a trouser pocket with the screen in an unlocked state, or in a scenario where an alarm clock is switched off by touching the screen with a palm, the difference between the touch signals of different channels will be equal to 0, and when the touch screen or the touch pad is not touched, the difference between the touch signals of different channels will also be equal to 0, thereby failing to determine whether the touch screen or the touch pad is effectively touched. The output end of the mean value amplification submodule 123 is connected to the processing module 13, and the error signal outputted from the mean value amplification submodule 123 is processed by the processing module 13 and converted into a digital signal. The digital signal is different when the touch screen or the touch pad is touched on a large area and when the touch screen or the touch pad is not touched, so that whether the touch screen or the touch pad is effectively touched can be determined based on the digital signal.

The amplification submodule 111 outputs the output signal based on the error signal and the input signal inputted from the electrode 20. The error signal is transmitted to the non-inverting input end of the first amplifier A1, thereby increasing the reference base for the output signal relative to the input signal. During touch recognition based on the digital signal converted from the touch voltage signal, it is necessary to compensate using software a diff of different channels based on the reference base of the digital signal. Therefore, when the error signal is converted into the corresponding digital signal via the processing module 13, the software can compensate the digital signal converted from the touch voltage signal based on the digital signal converted from the error signal.

In an embodiment of the present disclosure, the output end of the mean value amplification submodule 123 is connected to one of the processing modules 13. The processing module 13 filters the error signal outputted from the mean value amplification submodule 123 and converts it into a corresponding digital signal. The digital signal can be used as data reference for software compensation for the diff of each channel, to ensure normal touch recognition. Moreover, when the touch screen or the touch pad is touched on a large area, whether the touch screen or the touch pad is effectively touched can also be determined based on the digital signal to ensure the touch recognition accuracy.

In a possible implementation, as shown in FIG. 4, the filter 131 comprises: a differential amplifier B, a second DC voltage source V2, a second driving unit T2, a third switch S3, a fourth switch S4, a fourteenth resistor R14, a fifteenth resistor R15, a sixteenth resistor R16, a seventeenth resistor R17, an eighteenth resistor R18, a nineteenth resistor R19, a tenth capacitor C10, an eleventh capacitor C11, and a twelfth capacitor C12.

A first end of the fourteenth resistor R14 is connected to the second end of the third resistor R3, and the second ends of the different third resistors R3 are connected to the first ends of the fourteenth resistors R14 in different filters 13. A second end of the fourteenth resistor R14 is connected to a first end of the sixteenth resistor R16, and a second end of the sixteenth resistor R16 is connected to a positive input end of the differential amplifier B. A first end of the seventeenth resistor R17 is connected to the first end of the sixteenth resistor R16, and a second end of the seventeenth resistor R17 is connected to a negative output end of the differential amplifier B. A first end of the eleventh capacitor C11 is connected to the second end of the sixteenth resistor R16, and a second end of the eleventh capacitor C11 is connected to the negative output end of the differential amplifier B.

A first end of the fifteenth resistor R15 is connected to a first end of the third switch S3 and a first end of the fourth switch S4 respectively, a second end of the third switch S3 is connected to the second DC voltage source V2, and a second end of the fourth switch S4 is connected to the second driving unit T2. A second end of the fifteenth resistor R15 is connected to a first end of the eighteenth resistor R18, and a second end of the eighteenth resistor R18 is connected to a negative input end of the differential amplifier B. A first end of the nineteenth resistor R19 is connected to the first end of the eighteenth resistor R18, and a second end of the nineteenth resistor R19 is connected to a positive output end of the differential amplifier B. A first end of the twelfth capacitor C12 is connected to the second end of the eighteenth resistor R18, and a second end of the twelfth capacitor C12 is connected to the positive output end of the differential amplifier B.

A first end of the tenth capacitor C10 is connected to the first end of the sixteenth resistor R16, a second end of the tenth capacitor C10 is connected to the first end of the eighteenth resistor R18, and the positive output end and the negative output end of the differential amplifier are connected to the sample holder 132 respectively.

In a mutual capacitive mode, the third switch S3 is switched on, the fourth switch S4 is switched off, and the second DC voltage source V2 outputs a DC voltage same as the reference voltage signal. In a self-capacitive mode, the third switch S3 is switched off, the fourth switch S4 is switched on, and the second driving unit t2 outputs a driving signal equal to the reference voltage signal.

The filter 131 not only needs to filter an input, but also removes the reference voltage signal included in the input signal. As shown in FIG. 4, in the mutual capacitive mode, the first switch S1 is switched on, the second switch S2 is switched off, and the first DC voltage source V1 transmits a DC voltage as the reference voltage signal to the output end of the switching submodule 122. In this case, the reference voltage signal included in the input signal of the filter 131 is a DC level. In order for the filter 131 to remove the reference voltage signal included in the input signal, the third switch S3 is switched on, and the fourth switch S4 is switched off, so that the second DC voltage source V2 outputs the DC voltage equal to the reference voltage, and then the filter 131 can remove the reference voltage signal included in the input signal based on the DC voltage outputted from the second DC voltage source V2.

In the self-capacitive mode, the first switch S1 is switched off, the second switch S2 is switched on, and the first driving unit T1 transmits a self-capacitive driving signal as the reference voltage signal to the output end of the switching submodule 122. In this case, the reference voltage signal included in the input signal of the filter 131 is a self-capacitive driving signal, and the self-capacitive driving signal outputted from the first driving unit T1 is equal to the driving signal acting on the electrode 20. In order for the filter 131 to remove the reference voltage signal included in the input signal, the third switch S3 is switched off, and the fourth switch S4 is switched on, so that the second driving unit T2 outputs a driving signal equal to the reference voltage signal, and then the filter 131 can remove the reference voltage signal included in the input signal based on the driving signal outputted from the second driving unit T2.

In an example, the first DC voltage source V1 and the second DC voltage source V2 may output an equal DC level, and the first driving unit T1 and the second driving unit T2 may output an equal self-capacitive driving signal with phase and amplitude same as those of the driving signal acting on the electrode 20.

In an embodiment of the present disclosure, the filter 131 comprises the third switch S3 and the fourth switch S4, wherein the third switch S3 is connected to the second DC voltage source V2, and the third switch S4 is connected to the second driving unit T2. In the mutual capacitive mode, the third switch S3 is switched on, the fourth switch S4 is switched off, and the second DC voltage source V2 outputs a DC level same as the reference voltage signal, so that the filter 131 can remove the reference voltage signal introduced by the first DC voltage source V1. In the self-capacitive mode, the third switch S3 is switched off, the fourth switch S4 is switched on, and the second driving unit T2 outputs a self-capacitive driving signal equal to the reference voltage signal, so that the filter 131 can remove the reference voltage signal introduced by the first driving unit T1, thereby removing the reference voltage signal included in the input signal of the filter 131 in both the mutual capacitive mode and the self-capacitive mode, and ensuring the touch recognition accuracy in the mutual capacitive mode and in the self-capacitive mode.

In an example, the amplification submodule 111 adopts the solution shown in FIG. 4, the accumulation submodule 121 adopts the solution shown in FIG. 4, the mean value amplification submodule 123 adopts the solution shown in FIG. 5, a capacitance value of the first capacitor C1 is 60 pF, a resistance value of the first resistor R1 is 1 KΩ, a resistance value of the second resistor R2 is 10 KΩ, a resistance value of the third resistor R3 is 1 KΩ, a capacitance value of the second capacitor C2 is 2 pF, a capacitance value of the third capacitor is 100 pF, and a resistance value of the fourth resistor R4 is 5 KΩ.

FIG. 9 shows a phase margin evaluation result of a touch detection circuit in this example. As shown in FIG. 9, when loading of a touch screen or a touch pad is less than or equal to 500 pF, a phase margin may be above 45° in the case of reducing the costs of the touch detection circuit using a capacitor with a small capacitance value and a resistor with a small resistance value, and when the loading of the touch screen or the touch pad is less than 500 pF, the phase margin is still above 45°, so that the touch detection circuit can work stably and normally. The phase margin (PM) refers to a difference (unit: degree) between 180° and phase of an output signal from an amplifier (relative to its input) when a gain is 0. The industry requires the phase margin to be greater than 45°. If a difference between 180° and the phase of the output signal from the amplifier is less than 135°, the system will oscillate, thus failing to work normally.

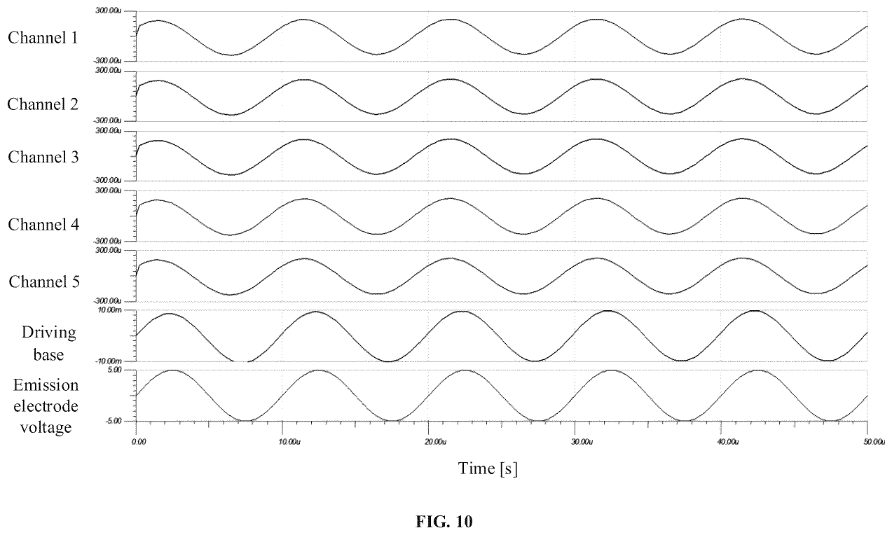

FIG. 10 shows a suppression effect of a touch detection circuit on a mutual capacitive driving base in an embodiment of the present disclosure. As shown in FIG. 10, when the test conditions are a maximum cutoff frequency of the first amplifier A1 GBW=10 MHz, a maximum slew rate SR=20 V/μs, an open-loop gain of 120 dB, a main node at 10 Hz, and a second pole at 100 MHz, the mutual capacitive driving base can substantially be suppressed. Remaining mutual capacitive driving base is 0.4 mVpp during driving using an input electrode (TX) at 10 Vpp, which basically does not occupy the dynamic range of the amplification submodule 111. When the first capacitor C1 is 500 pF, the remaining mutual capacitive driving base is 20 mVpp during driving at 10 Vpp, and the suppression efficiency is approximately 0.4/20/20=99.9%.

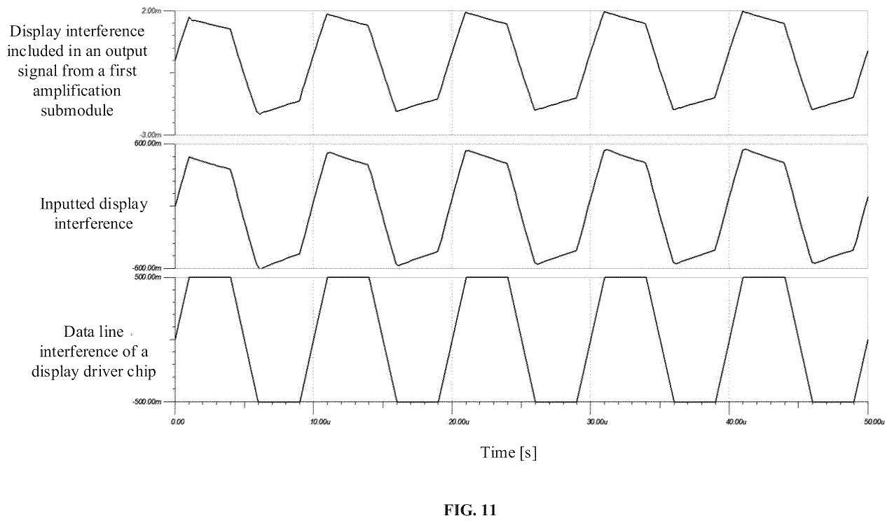

FIG. 11 shows a suppression effect of a touch detection circuit on display interference in an embodiment of the present disclosure. As shown in FIG. 11, when the test conditions are a maximum cutoff frequency of the first amplifier A1 GBW=10 MHz, a maximum slew rate SR=20 V/μs, an open-loop gain of 120 dB, a main node at 10 Hz, and a second pole at 100 MHz, the display interference can substantially be suppressed. Under a display interference input at 1 Vpp, remaining display interference in an output signal from the amplification submodule 111 is 4 mVpp, which basically does not occupy the dynamic range of the amplification submodule 111. When the first capacitor C1 is 500 pF and the display interference input is 1 Vpp, the remaining display interference in the output signal from the amplification submodule 111 is 4 mVpp, and the suppression efficiency is approximately 0.4/1/20=99.8%.

FIGS. 10 and 11 show actual measurement results of simulated and prototype platforms. By suppressing mutual capacitive driving base and display interference, that is, corresponding subtraction is made after obtaining mean values of the driving base and the display interference of each sensing electrode channel. There is a small difference between interchannel driving base and the display interference, and both the driving base and the display interference of each channel are substantially around the mean value. Therefore, there is a small residual amount of the driving base and the display interference after subtraction, which can be suppressed to within 1 mVpp in actual measurements.

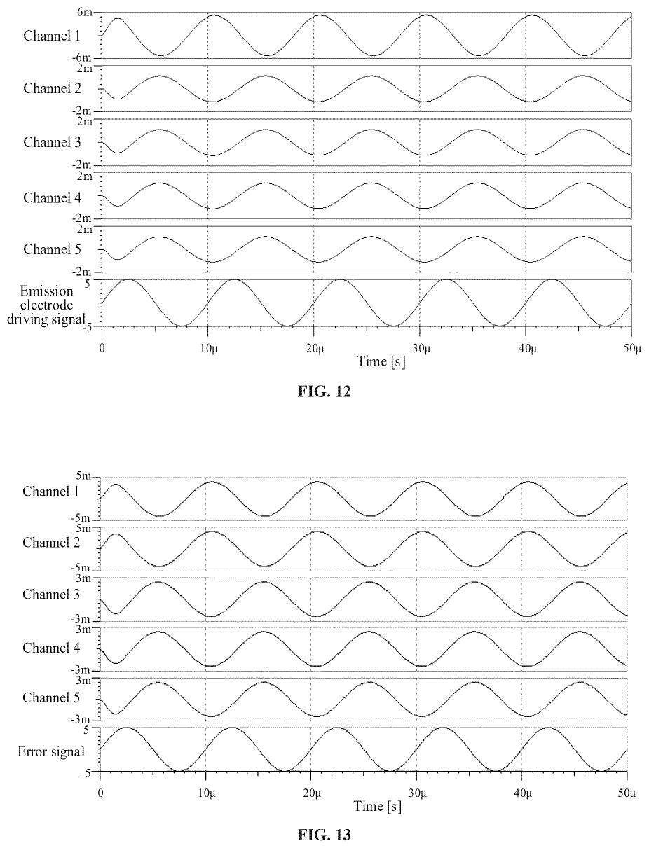

FIGS. 12 and 13 show a mutual capacitive touch diff effect of a touch detection circuit in an embodiment of the present disclosure, wherein FIG. 12 shows a mutual capacitive touch diff effect when 1 channel among 5 channels is touched, and FIG. 13 shows a mutual capacitive touch diff effect when 2 channels among the 5 channels are touched. As shown in FIG. 12, when a single channel is touched, a diff of the channel is 10 mVpp, while a diff of other channels is 2 mVpp. After compensation for the mean base (error signal), an actual diff of the channel is 12 mVpp. As shown in FIG. 13, when two channels are touched, a diff of the two channels is 8 mVpp, while a diff of other channels is 4 mVpp. After compensation for the mean base, an actual diff of the two channels is 12 mVpp. As shown in FIGS. 12 and 13, the touch detection circuit can normally amplify the touch signal, and the mutual capacitive diff is approximately 12 mVpp. Since the diff is not lost, after the driving base and the display interference are suppressed, noise in the touch signal is reduced, the SNR can be obviously improved, and the diff is compensated through a mean value channel based on a touched channel and a non-touched channel. For example, channel 0 among 6 channels is touched, a diff of the channel 0 is 10 mV, a mean value channel output is 2 mV, a compensated diff of the channel 0 is 12 mV, and the mean value channel output is 12 mV/6=2 mV.

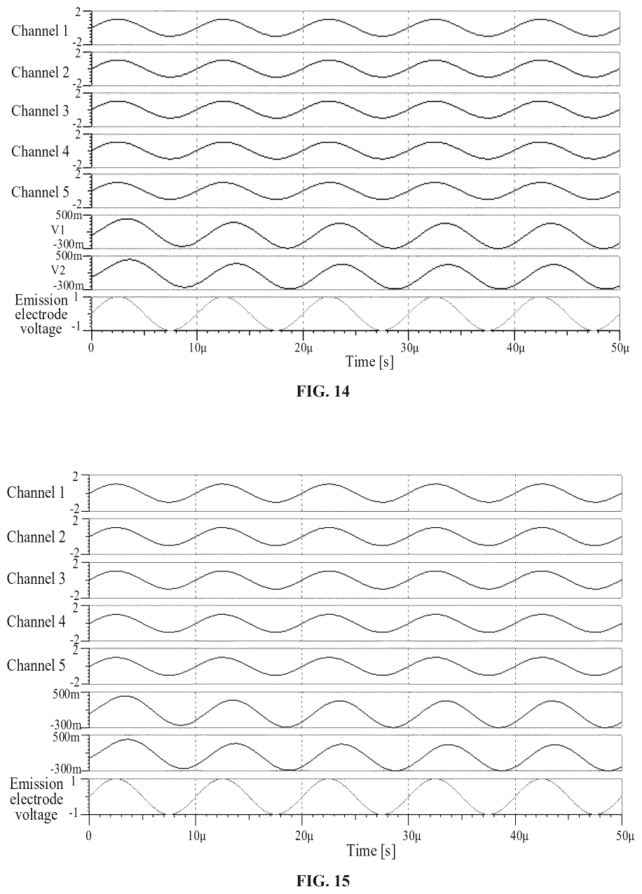

FIGS. 14 and 15 show a self-capacitive touch diff effect of a touch detection circuit in an embodiment of the present disclosure. In FIG. 14, a vertical coordinate V1 represents an input signal of a non-inverting input end of a first amplifier A1 in an amplification submodule 111, and the vertical coordinate represents an input signal of an inverting input end of the first amplifier A1 in the amplification submodule 111. The V1 and V2 are controlled to be equal based on virtual short circuits of an operational amplifier. Since the non-inverting input end of the first amplifier A1 is connected to an output end of a mean value amplification submodule 123, the V1 and the V2 may also represent output signals from the mean value amplification submodule 123, that is, a mean value obtained from signals of each channel.

As shown in FIG. 14, when no touch is present, an output from the amplification submodule 111 in each channel among the 5 channels comprises an output electrode (TX) base, for example, TX=2 Vpp in FIG. 14. As shown in FIG. 15, when 1 channel among the 5 channels is touched, the diff is approximately 1 mVpp, wherein a first capacitor C1=300 pF, a self-capacitive diff is 0.35 pF, an output electrode base is 2 Vpp, and a driving frequency is 100 KHz. As shown in FIGS. 14 and 15, the touch detection circuit can normally amplify the touch signal, and the self-capacitive diff is approximately 1 mVpp. FIGS. 14 and 15 are actual measurement results of a touch detection circuit provided in an embodiment of the present disclosure. The self-capacitive diff is not lost, and the driving base and the display interference are suppressed, thereby reducing the display interference while increasing the amplification ratio, and further improving the SNR.

### Touch Chip

An embodiment of the present disclosure provides a touch chip, comprising the touch detection circuit 10 in any one of the above embodiments, that is, the touch detection circuit 10 in the above embodiments is encapsulated in a chip, and the touch chip may be arranged in an electronic device comprising a touch screen or a touch pad for touch recognition.

It should be noted that the touch chip in an embodiment of the present disclosure is based on the same concept as the touch detection circuit in the above embodiments, and the description of the touch detection circuit in the above embodiments may be referred to for specific content and beneficial effects thereof, which will not be repeated here.

### Screen Module

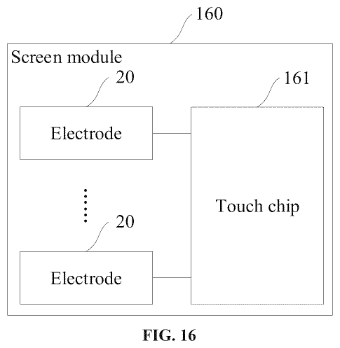

FIG. 16 is a schematic diagram of a screen module in an embodiment of the present disclosure. As shown in FIG. 16, the screen module 160 comprises the touch chip 161 in the above embodiments and a plurality of electrodes 20, and the touch chip 161 comprises a touch detection circuit 10 in any one of the above embodiments.

The electrode 20 may receive a touch drive signal outputted from the touch chip 161, so that the screen module 160 recognizes a touch instruction. The electrode 20 may be a horizontal electrode and/or a vertical electrode arranged on a touch screen.

It should be noted that the screen module in an embodiment of the present disclosure is implemented based on the touch detection circuit 10 and the touch chip in the above embodiments. The description of the touch detection circuit in the above embodiments is referred to for specific applications, specific contents, and beneficial effects of the touch detection circuit 10 and the touch chip in the above embodiments, which will not be repeated here.

It should be understood that the embodiments in the present specification are described progressively, identical or similar portions among the embodiments may be mutually referred to, and differences of each embodiment from other embodiments are mainly described in the embodiment. In particular, the method embodiments are substantially similar to the method described in the apparatus and system embodiments, which are therefore relatively simply described. A part of description of other embodiments may be referred to for relevant details.

It should be understood that particular embodiments of the present specification are described above. Other embodiments are encompassed within the scope of the claims. In some cases, actions or steps disclosed in the claims may be executed in an order different from that in embodiments, and can still achieve desired results. In addition, the processes depicted in the drawings are not necessarily required to achieve the desired results in the shown particular order or in a sequential order. In some embodiments, multitasking and parallel processing may also be feasible, or may be advantageous.

It should be understood that an element described herein in a singular form or only one of the element shown in the drawings does not mean that the number of the element is limited to one. Further, modules or elements described or shown as separate modules or elements herein may be combined into a single module or element, and a module or element described or shown as a single module or element herein may be split into a plurality of modules or elements.

It should be further understood that the terms and expressions used herein are for description only, and one or more embodiments of the present specification should not be limited to these terms and expressions. The use of these terms and expressions does not mean to exclude equivalent features of any illustrations and descriptions (or parts thereof), and it should be appreciated that various possible modifications should also be included within the scope of the claims. There may also be other modifications, alterations, and replacements. Accordingly, the claims should be deemed to cover all these equivalents.

1. A touch detection circuit, connected to a plurality of electrodes; wherein
the touch detection circuit is configured to process input signals inputted from the plurality of electrodes to obtain a touch signal corresponding to each of the electrodes, wherein the touch signal is used to indicate a touch state of a touch region where the electrode is located;
when no finger touch is present, a touch signal corresponding to each of the electrodes is a first touch signal; and when a finger touch is present, a touch signal corresponding to one of the electrodes located in a touch region with the finger touch is a second touch signal, a touch signal corresponding to one of the electrodes located in a touch region without the finger touch is a third touch signal, and each of the second touch signal and the third touch signal is different from the first touch signal.

2. The touch detection circuit according to claim 1, wherein a signal number of the second touch signal is negatively correlated with a number of the electrodes located in the touch region with the finger touch, and a signal number of the third touch signal is positively correlated with the number of the electrodes located in the touch region with the finger touch.

3. The touch detection circuit according to claim 1, wherein a sum of the signal number of the second touch signal and the signal number of the third touch signal is equal when different numbers of the electrodes are located in the touch region with the finger touch.

4. The touch detection circuit according to claim 1, wherein the touch detection circuit comprises an analog-to-digital conversion module, and the touch signal is outputted from the analog-to-digital conversion module.

5. The touch detection circuit according to claim 4, wherein the touch detection circuit comprises an amplification module and a feedback module; wherein
the amplification module comprises a plurality of amplification submodules, different amplification submodules being connected to different electrodes;
the feedback module is configured to generate an error signal based on an output signal outputted from each of the amplification submodules and transmit the error signal to each of the amplification submodules, wherein the error signal is used to indicate a mean intensity of an interference signal coupled to each of the electrodes; and
the amplification submodule is configured to output the output signal based on the input signal inputted from one of the electrodes connected to the amplification submodule and the error signal, wherein the output signal is used to generate the touch signal corresponding to the electrode connected to the amplification submodule.

6. The touch detection circuit according to claim 5, wherein the feedback module comprises an accumulation submodule, a switching submodule, and a mean value amplification submodule; wherein
a plurality of input ends of the accumulation submodule are connected to the amplification submodules respectively;
two input ends of the mean value amplification submodule are connected to the accumulation submodule and the switching submodule respectively, an output end of the mean value amplification submodule is connected to an input end of each of the amplification submodules;
the accumulation submodule is configured to obtain an accumulated current based on the output signal from each of the amplification submodules and transmit the accumulated current to the mean value amplification submodule, wherein the accumulated current is used to indicate a total intensity of the interference signal coupled to each of the electrodes;
the switching submodule is configured to transmit a reference voltage signal to the mean value amplification submodule; and
the mean value amplification submodule is configured to generate the error signal based on the accumulated current and the reference voltage signal, and transmit the error signal to each of the amplification submodules.

7. The touch detection circuit according to claim 6, wherein the amplification submodule comprises a first amplifier, a first resistor, a second resistor, and a first capacitor; wherein
a first end of the first resistor is connected to the electrode, a second end of the first resistor is connected to an inverting input end of the first amplifier;
a first end of the second resistor is connected to the inverting input end of the first amplifier, a second end of the second resistor is connected to an output end of the first amplifier;
a first end of the first capacitor is connected to the inverting input end of the first amplifier, a second end of the first capacitor is connected to the output end of the first amplifier;
a non-inverting input end of the first amplifier is connected to the mean value amplification submodule, the output end of the first amplifier is connected to the accumulation submodule, the first amplifier transmits the output signal to the accumulation submodule via the output end, and the mean value amplification submodule transmits the error signal to the non-inverting input end of the first amplifier.

8. The touch detection circuit according to claim 7, wherein the accumulation submodule comprises a plurality of third resistors; wherein
a first end of each of the third resistors is connected to the output end of the first amplifier, a second end of the third resistor is connected to an input end of the mean value amplification submodule, the first ends of different third resistors are connected to different first amplifiers, and the second ends of the different third resistors are connected to a given input end of the mean value amplification submodule.

9. The touch detection circuit according to claim 8, wherein the mean value amplification submodule comprises: a second amplifier, a second capacitor, a third capacitor, a fourth resistor, and a fifth resistor; wherein
a non-inverting input end of the second amplifier is connected to the switching submodule, an inverting input end of the second amplifier is connected to a first end of the fifth resistor, a second end of the fifth resistor is connected to the second end of each of the third resistors;
an output end of the second amplifier is connected to the non-inverting input end of each of the first amplifiers, a first end of the fourth resistor is connected to the output end of the second amplifier, a second end of the fourth resistor is connected to a first end of the third capacitor, a second end of the third capacitor is connected to the inverting input end of the second amplifier;
a first end of the second capacitor is connected to the output end of the second amplifier, and a second end of the second capacitor is connected to the inverting input end of the second amplifier.

10. The touch detection circuit according to claim 8, wherein the mean value amplification submodule comprises: a third amplifier, a fourth capacitor, a fifth capacitor, a sixth capacitor, a sixth resistor, a seventh resistor, and an eighth resistor; wherein
a non-inverting input end of the third amplifier is connected to the switching submodule, an inverting input end of the third amplifier is connected to a first end of the eighth resistor, a second end of the eighth resistor is connected to the second end of each of the third resistors;
an output end of the third amplifier is connected to the non-inverting input end of each of the first amplifiers, a first end of the sixth resistor is connected to an output end of the third amplifier, a second end of the sixth resistor is connected to a first end of the fifth capacitor, a second end of the fifth capacitor is connected to a first end of the fourth capacitor, a second end of the fourth capacitor is connected to a first end of the seventh resistor, a second end of the seventh resistor is connected to a second end of the eighth resistor;
a first end of the sixth capacitor is connected to the output end of the third amplifier, and a second end of the sixth capacitor is connected to the second end of the fifth capacitor and the inverting input end of the third amplifier respectively.

11. The touch detection circuit according to claim 8, wherein the mean value amplification submodule comprises: a fourth amplifier, a seventh capacitor, an eighth capacitor, a ninth resistor, a tenth resistor, and an eleventh resistor; wherein
a non-inverting input end of the fourth amplifier is connected to the switching submodule, an inverting input end of the fourth amplifier is connected to a first end of the eleventh resistor, a second end of the eleventh resistor is connected to the second end of each of the third resistors;
an output end of the fourth amplifier is connected to the non-inverting input end of each of the first amplifiers, a first end of the ninth resistor is connected to the output end of the fourth amplifier, a second end of the ninth resistor is connected to a first end of the eighth capacitor, a second end of the eighth capacitor is connected to a first end of the seventh capacitor and the inverting input end of the fourth amplifier respectively, a second end of the seventh capacitor is connected to a first end of the tenth resistor, and a second end of the tenth resistor is connected to the second end of the eleventh resistor.

12. The touch detection circuit according to claim 8, wherein the mean value amplification submodule comprises: a fifth amplifier, a ninth capacitor, a twelfth resistor, and a thirteenth resistor; wherein
a non-inverting input end of the fifth amplifier is connected to the switching submodule, an inverting input end of the fifth amplifier is connected to a first end of the thirteenth resistor, a second end of the thirteenth resistor is connected to the second end of each of the third resistors;
a first end of the twelfth resistor is connected to an output end of the fifth amplifier, a second end of the twelfth resistor is connected to a first end of the ninth capacitor, and a second end of the ninth capacitor is connected to the inverting input end of the fifth amplifier.

13. The touch detection circuit according to claim 9, wherein the switching submodule comprises: a first DC voltage source, a first driving unit, a first switch, and a second switch; wherein
an output end of the switching submodule is connected to a first end of the first switch and a first end of the second switch respectively, a second end of the first switch is connected to the first DC voltage source, a second end of the second switch is connected to the first driving unit;
in a mutual capacitive mode, the first switch is switched on, the second switch is switched off, and the first DC voltage source transmits a DC voltage as the reference voltage signal to the output end of the switching submodule; and
in a self-capacitive mode, the first switch is switched off, the second switch is switched on, and the first driving unit transmits a self-capacitive driving signal as the reference voltage signal to the output end of the switching submodule, wherein the self-capacitive driving signal outputted from the first driving unit is equal to a driving signal acting on the electrode.

14. The touch detection circuit according to claim 8, wherein the touch detection circuit further comprises a plurality of processing modules, each of the processing modules comprising a filter, a sample holder, and a buffer submodule; wherein
an output end of the filter is connected to an input end of the sample holder, an output end of the sample holder is connected to an input end of the buffer submodule, and an output end of the buffer submodule is connected to an input end of the analog-to-digital conversion module, wherein the second ends of the different third resistors are connected to input ends of the filters in different processing modules, the output ends of the buffer submodules in the different processing modules are connected to the input ends of different analog-to-digital conversion modules;
the filter is configured to filter the input signal and remove the reference voltage signal included in the input signal to obtain a touch voltage signal;
the sample holder is configured to sample the touch voltage signal to obtain a target signal and hold the target signal; and
the buffer submodule is configured to transmit the target signal changelessly to the analog-to-digital conversion module, so that the analog-to-digital conversion module converts the target signal into the touch signal.

15. The touch detection circuit according to claim 14, wherein the non-inverting input end of each of the first amplifiers is connected to the input end of the filter in one of the processing modules.

16. The touch detection circuit according to claim 14, wherein the filter comprises: a differential amplifier, a second DC voltage source, a second driving unit, a third switch, a fourth switch, a fourteenth resistor, a fifteenth resistor, a sixteenth resistor, a seventeenth resistor, an eighteenth resistor, a nineteenth resistor, a tenth capacitor, an eleventh capacitor, and a twelfth capacitor; wherein
a first end of the fourteenth resistor is connected to the second end of the third resistor, wherein the second ends of the different third resistors are connected to the first ends of the fourteenth resistors in different filters;
a second end of the fourteenth resistor is connected to a first end of the sixteenth resistor, a second end of the sixteenth resistor is connected to a positive input end of the differential amplifier, a first end of the seventeenth resistor is connected to a first end of the sixteenth resistor, a second end of the seventeenth resistor is connected to a negative output end of the differential amplifier, a first end of the eleventh capacitor is connected to a second end of the sixteenth resistor, a second end of the eleventh capacitor is connected to the negative output end of the differential amplifier;
a first end of the fifteenth resistor is connected to a first end of the third switch and a first end of the fourth switch respectively, a second end of the third switch is connected to the second DC voltage source, a second end of the fourth switch is connected to the second driving unit;
a second end of the fifteenth resistor is connected to a first end of the eighteenth resistor, a second end of the eighteenth resistor is connected to a negative input end of the differential amplifier, a first end of the nineteenth resistor is connected to a first end of the eighteenth resistor, a second end of the nineteenth resistor is connected to a positive output end of the differential amplifier, a first end of the twelfth capacitor is connected to the second end of the eighteenth resistor, a second end of the twelfth capacitor is connected to the positive output end of the differential amplifier;
a first end of the tenth capacitor is connected to the first end of the sixteenth resistor, a second end of the tenth capacitor is connected to the first end of the eighteenth resistor, the positive output end and the negative output end of the differential amplifier are connected to the sample holder respectively;
in a mutual capacitive mode, the third switch is switched on, the fourth switch is switched off, and the second DC voltage source outputs a DC voltage same as the reference voltage signal; and
in a self-capacitive mode, the third switch is switched off, the fourth switch is switched on, and the second driving unit outputs a driving signal equal to the reference voltage signal.

17. A touch chip, comprising a touch detection circuit connected to a plurality of electrodes; wherein
the touch detection circuit is configured to process input signals inputted from the plurality of electrodes to obtain a touch signal corresponding to each of the electrodes, wherein the touch signal is used to indicate a touch state of a touch region where the electrode is located;
when no finger touch is present, a touch signal corresponding to each of the electrodes is a first touch signal; and when a finger touch is present, a touch signal corresponding to one of the electrodes located in a touch region with the finger touch is a second touch signal, a touch signal corresponding to one of the electrodes located in a touch region without the finger touch is a third touch signal, and each of the second touch signal and the third touch signal is different from the first touch signal.

18. A screen module, comprising: a plurality of electrodes and the touch chip according to claim 17; wherein
each of the electrodes is configured to receive a touch drive signal outputted from the touch chip, so that the screen module recognizes a touch instruction, wherein the electrodes are horizontal electrodes and/or vertical electrodes arranged on the touch screen.
